(19) United States
(12) Patent Application Publication
(10) Pub. No.: US 2013/0061079 A1
(43) Pub. Date: Mar. 7, 2013

(54) IMAGE PROCESSING APPARATUS, METHOD FOR CONTROLLING THE SAME AND STORAGE MEDIUM

(71) Applicant: Junnosuke Kataoka, Yokohama-shi (JP)

(72) Inventor: Junnosuke Kataoka, Yokohama-shi (JP)

(73) Assignee: CANON KABUSHIKI KAISHA, Tokyo (JP)

(21) Appl. No.: 13/570,872

(22) Filed: Aug. 9, 2012

(30) Foreign Application Priority Data
Sep. 1, 2011 (JP) 2011-191073

(51) Int. Cl. G06F 1/32

(52) U.S. Cl. 713/323

(57) ABSTRACT

An image processing apparatus according to the present invention, when shifting from a normal operation state to a power saving state, obtains property information indicating a power supply capability from an external apparatus connected thereto via a DC power source line. Based on the obtained property information, the image processing apparatus controls supply of power from a power source unit to devices included in the image processing apparatus in a power saving state. Specifically, in the power saving state, the image processing apparatus supplies, to a portion of the devices, power supplied from the external apparatus via the DC power source line when the power supply capability of the external apparatus is higher than that of the image processing apparatus, and power supplied from a rechargeable battery when otherwise.

### BACKGROUND OF THE INVENTION

1. Field of the Invention

The present invention relates to image processing apparatuses, methods for controlling the image processing apparatuses, and a storage medium.

2. Description of the Related Art

In image processing apparatuses, such as MFPs, printers, and the like, there are several techniques for reducing power consumption in a standby state in which the functions are not being used. For example, in order to shift the image processing apparatus from the standby state to a power saving state in which power consumption is further reduced, the following three techniques are commonly used. A first technique is to reduce the power supplied to devices while keeping the power of the image processing apparatus on. A second technique is to turn off the power of the image processing apparatus.

If the first technique is employed in the image processing apparatus, in the power saving state the conversion efficiency (power source efficiency) from the primary side to the secondary side of the power source excessively decreases, resulting in significant power loss, and therefore, it is difficult to reduce power consumption compared to the normal operation state. If a two-converter power source is used, the power source efficiency is improved, but the cost of the apparatus increases. If the second technique is employed in the image processing apparatus, the power is turned off, and therefore the user has to manually operate a power switch or the like to turn on the power again. And the power source is activated from the off state, it takes a longer time to start up or activate the image processing apparatus.

To address the above problems, a third technique is to continue to supply required power to necessary devices by using a rechargeable battery while keeping the power of the image processing apparatus off. For example, Japanese Patent Laid-Open No. 2010-218317 has proposed a technique in which, when the main power source is put into the off state due to a sudden power failure or the like, power is supplied to a volatile memory using either a rechargeable battery or USB bus power in order to continue to hold what is stored in the memory. As a result, an image file and the like can continue to be stored in the volatile memory.

However, when the power consumption of the image processing apparatus is reduced by using the third technique, that is, the technique of continuing to supply power to the volatile memory using a rechargeable battery (Japanese Patent Laid-Open No. 2010-218317), it is necessary to charge the rechargeable battery at intervals. Specifically, if the output voltage of the rechargeable battery is low, the rechargeable battery cannot supply sufficient power to devices which need to be supplied with power in the power saving state. Therefore, when the output voltage of the rechargeable battery becomes low, it is necessary to activate the image processing apparatus from the power saving state (i.e., the main power source is put into the on state) so that the rechargeable battery is charged.

In particular, if the charge capacity of the rechargeable battery is small, the activation from the power saving state may be repeatedly performed at short time intervals in order to charge the rechargeable battery. In this case, because the rechargeable battery is repeatedly charged and discharged at short time intervals, the life of the rechargeable battery may decrease. On the other hand, if a rechargeable battery having a large capacity is used in order to increase the time intervals at which the rechargeable battery is charged and discharged and thereby reduce the frequency of charging/discharging, the cost of the apparatus related to the rechargeable battery may increase.

### SUMMARY OF THE INVENTION

The present invention has been made in view of the above problems. The present invention provides a technique of operating an image processing apparatus in which a rechargeable battery can be used to save power in the standby state, in cooperation with another image processing apparatus via a power source line to reduce the frequency of charging/discharging of the rechargeable battery, thereby increasing the life of the rechargeable battery.

According to one aspect of the present invention, there is provided an image processing apparatus comprising: a power source unit configured to, in a normal operation state, supply power supplied from a AC power source to a plurality of devices included in the image processing apparatus and charge a rechargeable battery included in the image processing apparatus, and in a power saving state in which power consumption is lower than in the normal operation state, supply power supplied from the rechargeable battery to a portion of the plurality of devices; an obtaining unit configured to, in a case where the image processing apparatus shifts from the normal operation state to the power saving state, obtain information indicating a power supply capability of another image processing apparatus connected to the image processing apparatus via a power source line different from a AC power source line through which power is supplied from the AC power source, via the power source line; a determination unit configured to determine whether or not the power supply capability of the another image processing apparatus indicated by the information obtained by the obtaining unit is higher than that of the image processing apparatus; and a control unit configured to control the power source unit to supply, to the portion of the plurality of devices, power supplied via the power source line from the another image processing apparatus in a case where the determination unit determines that the power supply capability of the another image processing apparatus is higher than that of the image processing apparatus, and power supplied from the rechargeable battery in a case where otherwise.

According to another aspect of the present invention, there is provided a method for controlling an image processing apparatus, the image processing apparatus including a power source unit configured to, in a normal operation state, supply power supplied from a AC power source to a plurality of devices included in the image processing apparatus and charge a rechargeable battery included in the image processing apparatus, and in a power saving state in which power consumption is lower than in the normal operation state, supply power supplied from the rechargeable battery to a portion of the plurality of devices, the method comprising: in a case where the image processing apparatus shifts from the normal operation state to the power saving state, obtaining information indicating a power supply capability of another image processing apparatus connected to the image processing apparatus via a power source line different from a AC power source line through which power is supplied from the AC power source, via the power source line; determining whether or not the power supply capability of the another image processing apparatus indicated by the information obtained by the obtaining is higher than that of the image processing apparatus; and controlling the power source unit to supply, to the portion of the plurality of devices in the power saving state, power supplied via the power source line from the another image processing apparatus in a case where it is determined that the power supply capability of the another image processing apparatus is higher than that of the image processing apparatus, and power supplied from the rechargeable battery in a case where otherwise.

According to still another aspect of the present invention, there is provided a computer-readable storage medium storing a computer program for causing a computer to execute steps of a method for controlling an image processing apparatus, the image processing apparatus including a power source unit configured to, in a normal operation state, supply power supplied from a AC power source to a plurality of devices included in the image processing apparatus and charge a rechargeable battery included in the image processing apparatus, and in a power saving state in which power consumption is lower than in the normal operation state, supply power supplied from the rechargeable battery to a portion of the plurality of devices, the method comprising: in a case where the image processing apparatus shifts from the normal operation state to the power saving state, obtaining information indicating a power supply capability of another image processing apparatus connected to the image processing apparatus via a power source line different from a AC power source line through which power is supplied from the AC power source, via the power source line; determining whether or not the power supply capability of the another image processing apparatus indicated by the information obtained by the obtaining is higher than that of the image processing apparatus; and controlling the power source unit to supply, to the portion of the plurality of devices in the power saving state, power supplied via the power source line from the another image processing apparatus in a case where it is determined that the power supply capability of the another image processing apparatus is higher than that of the image processing apparatus, and power supplied from the rechargeable battery in a case where otherwise.

According to the present invention, an image processing apparatus in which a rechargeable battery can be used to save power in the standby state is operated in cooperation with another image processing apparatus via a power source line, whereby the frequency of charging/discharging of the rechargeable battery can be reduced, and therefore, the life of the rechargeable battery can be increased. Also, power can be saved using a rechargeable battery having a relatively small capacity, and therefore, the cost of the apparatus related to the use of the rechargeable battery can be reduced. Moreover, power is saved in the standby state by a plurality of image processing apparatuses connected together via a power source line being operated in cooperation with each other, whereby the power consumption of an entire system including the plurality of image processing apparatuses can be efficiently reduced while the life of the rechargeable battery in each apparatus is increased.

Further features of the present invention will become apparent from the following description of exemplary embodiments (with reference to the attached drawings).

### BRIEF DESCRIPTION OF THE DRAWINGS

FIG. 1 is a block diagram showing an example configuration of an image processing system 100 according to an embodiment of the present invention.

FIG. 2 is a block diagram showing an example hardware configuration of an image processing apparatus 101 according to the embodiment of the present invention.

FIG. 3 is a block diagram showing an example configuration of a DC power source circuit unit 232 according to the embodiment of the present invention.

FIG. 4 is a flowchart showing a process of determining an operation mode of the image processing apparatus 101 of the embodiment of the present invention when the image processing apparatus 101 shifts to a power saving state.

FIG. 5 is a flowchart showing a process of shifting the image processing apparatus 101 of the embodiment of the present invention from a normal operation state to the power saving state.

FIG. 6 is a flowchart showing a process of returning the image processing apparatus 101 of the embodiment of the present invention in a cooperation mode from the power saving state to the normal operation state.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

<Configuration of Image Processing System>

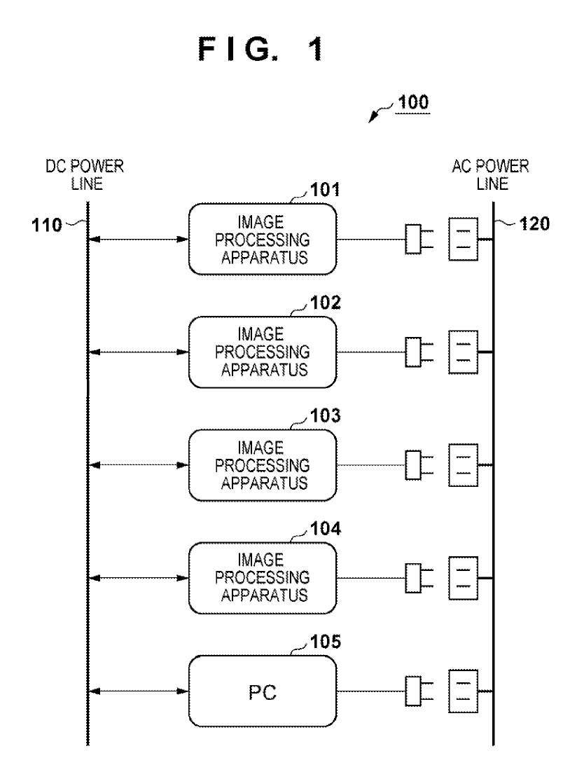

Firstly, an example configuration of an image processing system 100 according to an embodiment of the present invention will be described with reference to FIG. 1. The image processing system 100 includes a plurality of image processing apparatuses 101-104 and a computer (PC) 105. For example, the image processing apparatuses 101-104 are each a multi-function peripheral (MFP), and the PC 105 is a personal computer used by the user.

As shown in FIG. 1, the image processing apparatuses 101-104 and the PC 105 are each connected to an alternating current (AC) power source line 120 (commercial power source line) through which power supplied from a commercial power source is supplied, by an AC power cord thereof being connected to an AC power outlet. The image processing apparatuses 101-104 and the PC 105 can receive AC power from the AC power source line 120 via the AC power cord. The image processing apparatuses 101-104 in the normal operation state operate with the AC power supplied via the AC power source line 120.

The image processing apparatuses 101-104 and the PC 105 are each connected to a direct current (DC) power source line 110 by a DC cord thereof being connected to a DC power outlet. In this embodiment, the DC power source line 110 is provided separately from the commercial AC power source line 120, a local area network (LAN), a subscriber telephone line, and the like. The image processing apparatuses 101-104 and the PC 105 can each supply and receive DC power to and from another apparatus (external apparatus) which is connected thereto via the DC power source line 110. Thus, the image processing apparatuses 101-104 and the PC 105 of this embodiment can supply DC power to each other via the DC power source line 110.

The image processing apparatuses 101-104 each include a rechargeable battery which can be charged and discharged, and has a “power saving standby function” which is performed using the rechargeable battery. In this embodiment, the power saving standby function is to supply power to only a portion of a plurality of devices (loads) included in the apparatus in a standby state in which functions of the apparatus are not being used, thereby reducing power consumption. In particular, in this embodiment, the image processing apparatuses 101-104, when performing the power saving standby function, drive the portion of the devices using the rechargeable battery instead of the AC power source (main power source), whereby power consumption can be further reduced than when the portion of the devices are driven by the main power source. By performing the power saving standby function, the image processing apparatuses 101-104 shift from the standby state (normal standby state) to a power saving state (power saving standby state).

Note that the term “standby state” refers to a standby state (normal standby state) before the shift to the power saving state or after returning from the power saving state, unless otherwise specified. This standby state corresponds to one in which functions of the image processing apparatuses 101-104 are not used in the normal operation state other than the power saving state, and is a form of normal operation state.

In this embodiment, the image processing apparatuses 101-104 can perform the power saving standby function using a DC power source of an external apparatus which is connected thereto via the DC power source line 110, instead of their own rechargeable batteries. In other words, the image processing apparatuses 101-104 can shift from the normal operation state to the power saving state by the power saving standby function using either the rechargeable battery or the DC power source of an external apparatus. The image processing apparatuses 101-104, when any of the external apparatuses connected thereto via the DC power source line 110 performs the power saving standby function, can supply DC power to the external apparatus to function as a DC power source to the external apparatus.

In this embodiment, an operation mode in which when any of the image processing apparatuses 101-104 performs the power saving standby function, that image processing apparatus is supplied with power from another one of the image processing apparatuses 101-104 that is connected thereto via the DC power source line 110, hereinafter refers to a “cooperation mode.” On the other hand, an operation mode in which when any of the image processing apparatuses 101-104 performs the power saving standby function, that image processing apparatus is not supplied with power from any other of the image processing apparatuses 101-104 via the DC power source line 110, and uses its own rechargeable battery, refers to a “standalone mode.”

<Configuration of Image Processing Apparatus>

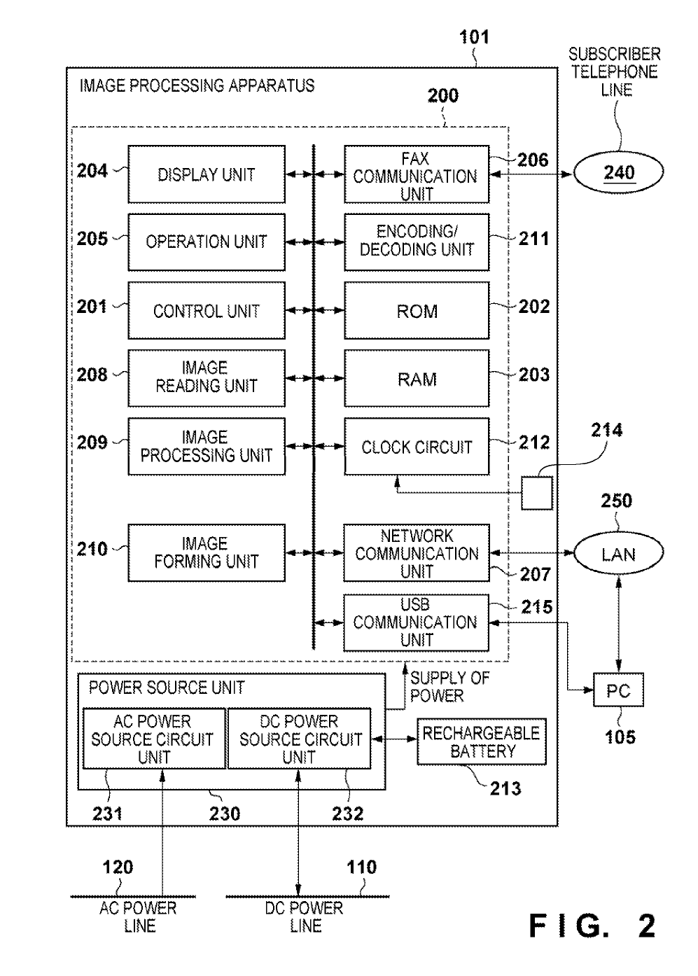

Next, a configuration of the image processing apparatus 101 of the embodiment of the present invention will be described with reference to FIG. 2. Note that the image processing apparatuses 102-104 have a configuration similar to that of the image processing apparatus 101. As shown in FIG. 2, the image processing apparatus 101 includes a control unit 201, a ROM 202, a RAM 203, a display unit 204, an operation unit 205, a fax communication unit 206, a network communication unit 207, an image reading unit 208, an image processing unit 209, an image forming unit 210, and an encoding/decoding unit 211. These devices are communicably connected together via a CPU bus 220. The CPU bus 220 functions as an address bus for transferring an address signal, a control bus for transferring a control signal, and a data bus for transferring various types of data, between the devices connected to the CPU bus 220.

The control unit 201 controls the operation of the entire image processing apparatus 101. The ROM 202 is a non-volatile storage device which stores a program executed by the control unit 201, various types of data, and the like. The RAM 203 is a volatile storage device in which a program executed by the control unit 201 is loaded under control by the control unit 201. The RAM 203 is also used as a work area for the control unit 201, an image memory area for the copy function, and an image memory area for the facsimile (fax) function.

A clock circuit 212 is a circuit which generates and outputs time information to the CPU bus 220. The clock circuit 212 is driven by power supplied from a primary battery 214, which is not rechargeable. Therefore, the clock circuit 212, even when a power source unit 230 is in the off state, can continue to generate and hold time information by power supplied from the primary battery 214.

The operation unit 205 includes various hard keys which are operated by the user and a touch panel which is provided on a surface of the display unit 204. The user can input instructions to the image processing apparatus 101 by operating the operation unit 205. The display unit 204 displays various items of information in the image processing apparatus 101. For example, the display unit 204 displays information for operation as an operation screen when the user operates the touch panel of the operation unit 205. The user can input instructions via the operation screen displayed on the display unit 204 by operating the touch panel.

The fax communication unit 206 performs fax communication with an external apparatus connected thereto via a subscriber telephone line 240. The fax communication unit 206 has various functions related to transmission and reception in fax communication. For example, the fax communication unit 206 has a memory reception function, a timer transmission function, and a battery backup function.

The memory reception function is to temporarily save received image data to the RAM 203 without outputting (printing) a received image based on the received image data directly to printing paper, and thereafter, print the received image based on the saved image data. The timer transmission function is to temporarily save to the RAM 203 image data corresponding to an image to be transmitted, and after a predetermined period of time has elapsed, transmit the image data saved in the RAM 203. The battery backup function is to, when the image processing apparatus 101 is in the power saving state, then even if an AC power source circuit unit 231 is in the off state, allow the RAM 203 to continue to store data in its image memory area for the fax function using power from the DC power source circuit unit 232.

The image reading unit 208 reads an image formed on a surface of an original, and outputs image data corresponding to the image. The image processing unit 209 performs an image process on the image data from the image reading unit 208 and an image process on image data which is used for image formation in the image forming unit 210.

The image forming unit 210 forms (prints) on printing paper an image based on image data. The image forming unit 210, when the image processing apparatus 101 performs the copy function, prints on printing paper an image based on the image data of the image read by the image reading unit 208. The image forming unit 210, when the image processing apparatus 101 performs the print function, prints on printing paper an image based on image data received from the PC 105 via the LAN 250.

The network communication unit 207 receives from the PC 105 the image data of an image to be printed, and transmits the image data of an image read by the image reading unit 208 to the PC 105 via the LAN 250. The network communication unit 207 communicates with an external apparatus (the PC 105 or the like) connected thereto via the LAN 250, i.e., transmits and receives data. For example, the network communication unit 207 provides a remote user interface function of accepting an HTTP connection from the PC 105 by a web browsing function, and communicating with the PC 105 via the HTTP connection. The PC 105 can control the image processing apparatus 101 using the remote user interface function via the HTTP connection established between the PC 105 and the network communication unit 207.

The encoding/decoding unit 211 encodes and decodes image data transmitted and received by the fax communication unit 206. Specifically, the encoding/decoding unit 211 encodes image data obtained by reading an original using the image reading unit 208, into fax communication data using a predetermined scheme before the image data is transmitted by the fax communication unit 206. The encoding/decoding unit 211 decodes fax communication data received by the fax communication unit 206 into image data using a predetermined scheme before an image is printed on printing paper by the image forming unit 210 based on the image data. When an original is copied over a plurality of pages, the encoding/decoding unit 211 encodes image data obtained by reading the pages of the original using the image reading unit 208 in order to temporarily save the image data to the RAM 203 or the like, and thereafter decodes the image data before the image data is printed.

A USB communication unit 215 communicates with an external apparatus connected thereto via a USB cable. In FIG. 2, as an example, the PC 105 is connected to the image processing apparatus 101 via a USB connection. For example, the USB communication unit 215 receives print image data from the PC 105 so that the image forming unit 210 prints an image on printing paper. The USB communication unit 215 also transfers to the PC 105 image data obtained by reading an original using the image reading unit 208. The USB communication unit 215 has a function of receiving power from an apparatus connected thereto via a USB cable using USB bus power (VBUS), which is a scheme that power is supplied from an apparatus connected via a USB cable.

The power source unit 230 includes the AC power source circuit unit 231 (first power source circuit unit) and the DC power source circuit unit 232 (second power source circuit unit). The AC power source circuit unit 231 converts alternating current (AC) power supplied from the AC power source line 120 via an AC power cord connected to an AC power outlet into direct current (DC) power. The AC power source circuit unit 231 also supplies the obtained DC power to devices in a circuit 200 of the image processing apparatus 101 in the normal operation state. The devices in the circuit 200 may be driven by the DC power supplied from the AC power source circuit unit 231. On the other hand, in the power saving state, the AC power source circuit unit 231 is cut off from the AC power source line 120 into the off state the under control by the control unit 201.

The DC power source circuit unit 232 may receive DC power from the DC power source line 110, or conversely, may output DC power to the DC power source line 110. The DC power may be supplied from an external apparatus connected to the DC power source line 110. The image processing apparatus 101, when outputting DC power to the DC power source line 110, may supply the DC power to an external apparatus connected to the DC power source line 110.

The image processing apparatus 101 further includes a rechargeable battery 213 which can be charged and discharged. As described above, the DC power source circuit unit 232 is connected to the rechargeable battery 213, and can charge the rechargeable battery 213 with power supplied from the AC power source circuit unit 231, and can also be supplied with power from the rechargeable battery 213. Specifically, in the normal operation state, the DC power source circuit unit 232 receives a portion of DC power converted from AC power and output by the AC power source circuit unit 231, and charges the rechargeable battery 213 with the supplied DC power. In the power saving state, the DC power source circuit unit 232 can supply power stored in the rechargeable battery 213 to a portion of the devices included in the image processing apparatus 101.

<Configuration of DC Power Source Circuit Unit>

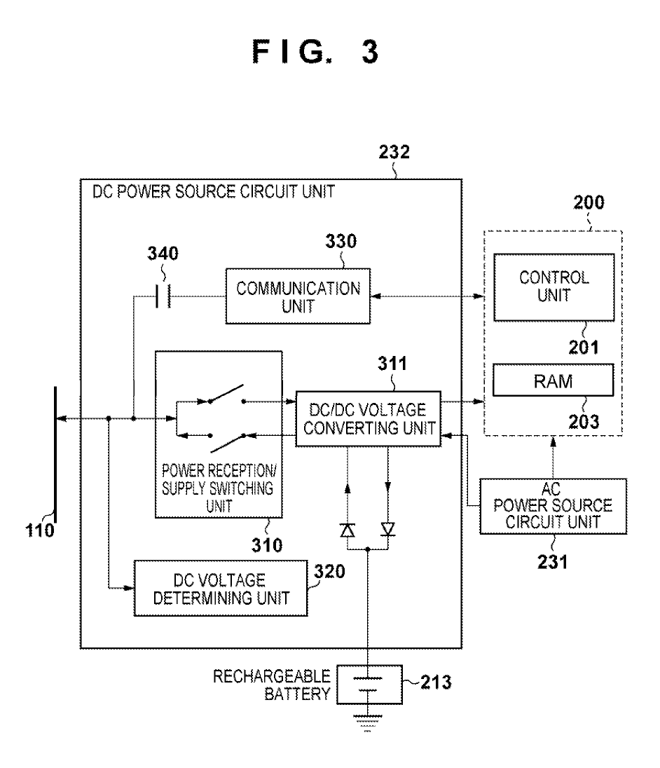

FIG. 3 is a block diagram showing a configuration of the DC power source circuit unit 232 provided in the power source unit 230. Devices in the DC power source circuit unit 232 of FIG. 3 are operated under control by the control unit 201. The DC power source circuit unit 232 is connected to the DC power source line 110 external to the image processing apparatus 101. The DC power source circuit unit 232 functions as a direct current (DC) power source for the devices in the circuit 200 of the image processing apparatus 101 or the external apparatuses 102-105 connected to the DC power source line 110.

The DC power source circuit unit 232 switches between receiving power from the DC power source line 110 and supplying power to the DC power source line 110, using a power reception/supply switching unit 310. When the power reception/supply switching unit 310 is set so that the DC power source circuit unit 232 receives power from the DC power source line 110, a DC/DC voltage converting unit 311 converts a DC voltage input from the DC power source line 110 via the power reception/supply switching unit 310 into a DC voltage suitable for operation of the image processing apparatus 101. The DC/DC voltage converting unit 311 outputs the DC voltage after the conversion to the circuit 200. On the other hand, when the power reception/supply switching unit 310 is set so that the DC power source circuit unit 232 supplies power to the DC power source line 110, the DC/DC voltage converting unit 311 converts a DC voltage generated by the AC power source circuit unit 231 into a DC voltage suitable for the DC power source line 110. The DC/DC voltage converting unit 311 outputs the DC voltage after the conversion to the DC power source line 110.

The DC/DC voltage converting unit 311 is connected to the rechargeable battery 213 and has a function of charging the rechargeable battery 213 with power supplied from the AC power source circuit unit 231 or receiving power from the rechargeable battery 213.

The control unit 201 uses a DC voltage determining unit 320 to determine whether or not power can be supplied from an external apparatus via the DC power source line 110 (i.e., whether or not the voltage of the DC power source line 110 meets the specifications of the image processing apparatus including that control unit 201). The DC voltage determining unit 320 connects an input terminal to the ground (GND) via a resistor having a relatively low resistance value (i.e., causes a short circuit) for a short time in response to an instruction from the control unit 201. The DC voltage determining unit 320 also determines the voltage of the DC power source line 110 based on a voltage drop caused by the resistor, and outputs the result of the determination to the control unit 201.

A communication unit 330 can communicate with the external apparatuses 102-105 connected to the DC power source line 110, via power line communications (PLC), under control by the control unit 201. Specifically, the communication unit 330 generates and transmits a high-frequency signal to the external apparatuses 102-105 connected to the DC power source line 110, and receives signals from the external apparatuses 102-105. DC components of the signal output from the communication unit 330 to the DC power source line 110 and the signal input from the DC power source line 110 to the communication unit 330 are removed by a capacitor 340. This is because the signal exchanged between the communication unit 330 and the communication units of the external apparatuses 102-105 is transmitted at a frequency higher than that of the DC component in which power is supplied. The communication unit 330 can transmit and receive property information about a DC power source to and from the external apparatuses 102-105 connected to the DC power source line 110, and negotiate the supply and reception of DC power.

<Process of Determining Operation Mode When Shifting to Power Saving State>

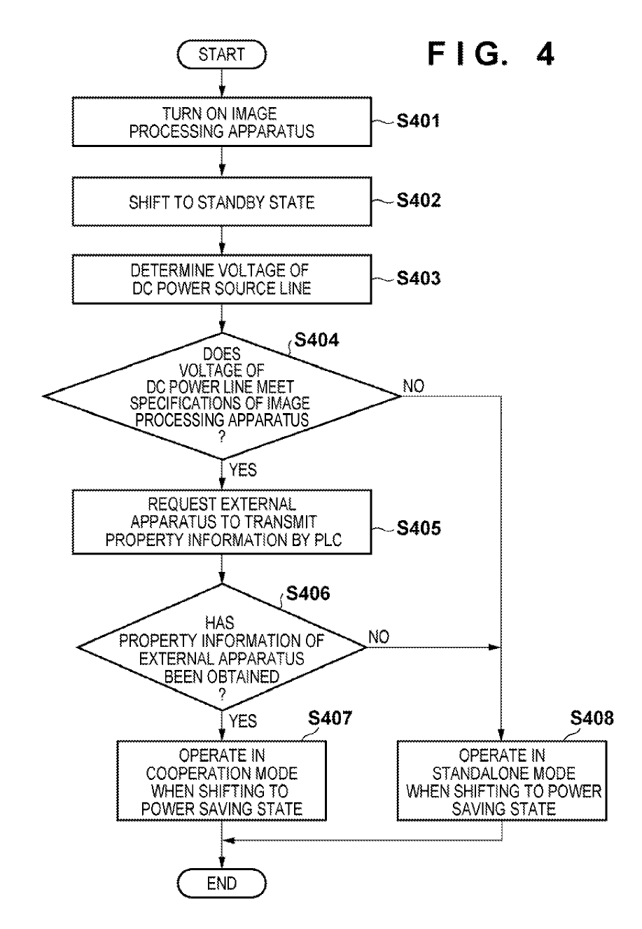

Next, a process of determining an operation mode when the image processing apparatus 101 shifts from the normal operation state to the power saving state will be described with reference to a flowchart shown in FIG. 4. Operations in steps shown in the flowchart of FIG. 4 are performed in the image processing apparatus 101 by the control unit 201 loading a control program stored in a storage device (the ROM 202 or the like) to the RAM 203 and executing the control program. Note that it is assumed that the image processing apparatus 101 is currently physically connected to the DC power source line 110 and the AC power source line 120 by the user.

In S401, the control unit 201, when the power switch provided in the operation unit 205 is switched from off to on by the user's operation, performs an initialization process for activating the image processing apparatus 101 from the power-off state. When the initialization process has been completed, the image processing apparatus 101 starts a normal operation using power from the AC power source circuit unit 231. Thereafter, in S402, the control unit 201 shifts to a standby state (normal standby state) during the normal operation. In this standby state, the image processing apparatus 101 can accept an instruction to execute a predetermined function or job from the operation unit 205, the PC 105, or the like.

Next, the control unit 201 controls the DC voltage determining unit 320 to determine the voltage of the DC power source line 110 in S403, and determines whether or not the determined voltage of the DC power source line 110 meets the specifications of the image processing apparatus including that control unit in S404. Specifically, the control unit 201 determines whether or not the DC power sources (e.g., the power source units 230) of the external apparatuses 102-105 connected to the DC power source line 110 can be used as a DC power source for the image processing apparatus including that control unit.

If the control unit 201 determines in S404 that the voltage of the DC power source line 110 does not meet the specifications of the image processing apparatus including that control unit, control proceeds to S408, and if the specifications are met, control proceeds to S405. In S405, the control unit 201 controls the communication unit 330 to request property information about the DC power sources of the external apparatuses 102-105 by means of PLC via the DC power source line 110.

In this embodiment, examples of the property information include the DC power source voltage of the external apparatus, the value of a current which can be supplied, the conversion efficiency (power source efficiency) of supplied power, a schedule in which power can be supplied, and information about the external apparatus itself (e.g., information indicating whether or not the external apparatus is in the normal operation state or in the power saving state, and the like). In this embodiment, the property information corresponds to information indicating the power supply capability of an image processing apparatus or an external apparatus. For example, the power source efficiency is the efficiency of conversion of AC power supplied from a commercial power source into DC power in the power source unit 230. As the power source efficiency increases, power loss occurring during the conversion decreases, i.e., the power supply capability increases.

In S406, the control unit 201 determines whether or not the property information has been obtained, using the communication unit 330, from at least one of the external apparatuses 102-105 connected to the DC power source line 110. Here, if the control unit 201 determines that the property information has not been obtained, control proceeds to S408, and if the property information was obtained, control proceeds to S407.

In S407, the control unit 201 determines that the image processing apparatus 101 is operated in the cooperation mode in which DC power is supplied from any external apparatus via the DC power source line 110 when the image processing apparatus 101 shifts from the normal operation state to the power saving state, and ends the process.

On the other hand, if the control unit 201 determines in S404 that the voltage of the DC power source line 110 does not meet the specifications of the image processing apparatus including that control unit, and if the control unit 201 determines in S406 that the property information has not been obtained, the control unit 201 performs the process of S408. In S408, the control unit 201 determines that the image processing apparatus 101 is operated in the standalone mode in which DC power is supplied from its own secondary battery 213 rather than external apparatuses when the image processing apparatus 101 shifts from the normal operation state to the power saving state, and ends the process. In this case, the control unit 201 controls the power reception/supply switching unit 310 so that the DC/DC voltage converting unit 311 is cut off from the DC power source line 110.

<Process of Shifting from Normal Operation State to Power Saving State>

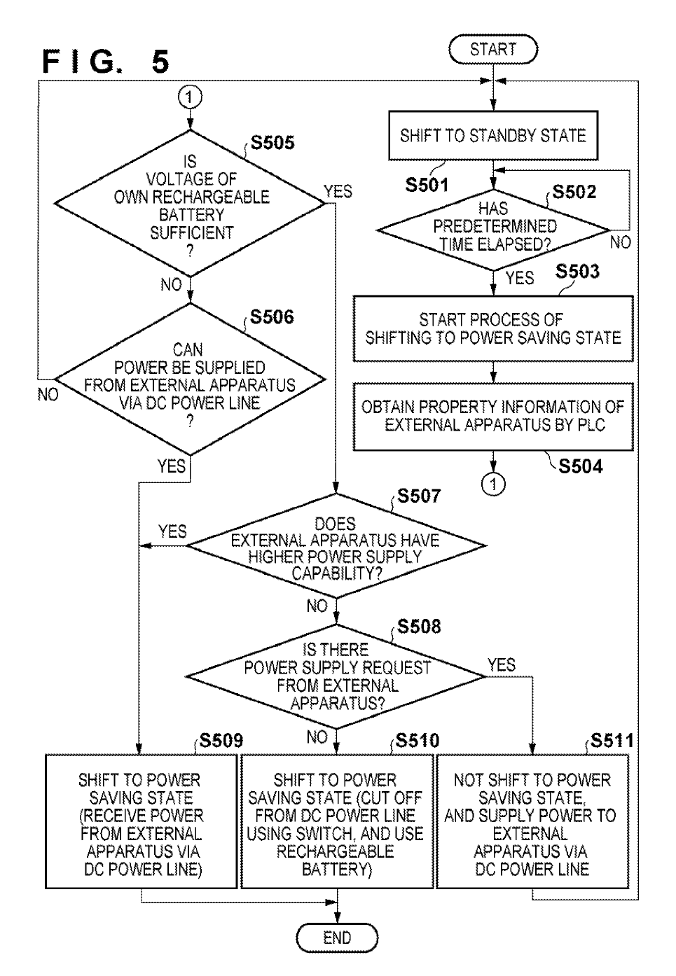

Next, a process of shifting from the normal operation state to the power saving state when it is determined that the image processing apparatus 101 is to be used in the cooperation mode, will be described with reference to a flowchart shown in FIG. 5. Operations in steps shown in the flowchart of FIG. 5 are performed in the image processing apparatus 101 by the control unit 201 loading a control program stored in a storage device (the ROM 202 or the like) to the RAM 203 and executing the control program.

When a job relating to any function, such as copying, faxing, printing, or the like, has been completed, the control unit 201 shifts the image processing apparatus 101 to the standby state in S501. Thereafter, in S502, the control unit 201 determines, based on the time information output from the clock circuit 212, whether or not a predetermined time has elapsed since shifting to the standby state. Here, upon determining that the predetermined time has not elapsed, the control unit 201 repeats the process of S502, and upon determining that the predetermined time has elapsed, control proceeds to S503.

In S503, the control unit 201 starts the process of shifting from the standby state to the power saving state. Initially, in S504, the control unit 201 controls the communication unit 330 to send a request for the property information about the DC power source of an external apparatus by means of PLC via the DC power source line 110 and obtain the property information. In other words, in S504, the control unit 201 functions as an obtaining unit.

Specifically, the communication unit 330 transmits to the DC power source line 110 a signal for determining an external apparatus which can supply DC power. When receiving the signal, any of the external apparatuses 102-105 connected to the DC power source line 110 that has a function of supplying DC power via the DC power source line 110, responds to the signal by transmitting the property information about the DC power source to the image processing apparatus 101. The control unit 201 of the image processing apparatus 101 receives, using the communication unit 330, the property information transmitted from the image processing apparatus 102 via the DC power source line 110.

Next, in S505, the control unit 201 determines the charge voltage of the rechargeable battery 213 included in the image processing apparatus including that control unit, and determines whether or not the charge voltage is sufficient so that the rechargeable battery 213 can be used as a DC power source. Here, the control unit 201 determines whether or not the charge voltage is sufficient, for example, by determining whether or not the charge voltage of the rechargeable battery 213 is higher than a predetermined threshold voltage. If the control unit 201 determines in step S505 that the charge voltage of the rechargeable battery 213 is not sufficient, control proceeds to S506.

In S506, the control unit 201 determines whether or not power can be supplied from any external apparatus via the DC power source line 110, by referencing the obtained property information. Here, if the control unit 201 determines that power cannot be supplied, none of the rechargeable battery 213 and the external apparatuses can be used to supply DC power, and therefore, it is not possible to shift to the power saving state, and therefore, control returns to S501. As a result, the image processing apparatus 101 continues to be in the standby state and charges the rechargeable battery 213 with power from the AC power source circuit unit 231. On the other hand, if the control unit 201 determines in step S506 that power can be supplied from any of the external apparatuses, control proceeds to S509.

If the control unit 201 determines in S505 that the charge voltage of the rechargeable battery 213 is sufficient, control proceeds to S507. In S507, based on the obtained property information of the external apparatus, the control unit 201 compares the power supply capability of the DC power source (the power source unit 230) of the external apparatus with the power supply capability of the rechargeable battery 213 included in the image processing apparatus including that control unit. If the control unit 201 determines in S507 that at least one external apparatus has a higher power supply capability than that of the image processing apparatus including that control unit, control proceeds to S509, and otherwise, control proceeds to S508.

When control proceeds from S506 or S507 to S509, in S509 the control unit 201 shifts the image processing apparatus 101 from the standby state (normal operation state) to the power saving state. Here, the control unit 201 controls the communication unit 330 to transmit to the DC power source line 110 a power supply request for requesting the external apparatuses 102-105 to supply DC power via the DC power source line 110. In this embodiment, it is assumed that, in response to the power supply request, the image processing apparatus 102 supplies DC power to the image processing apparatus 101.

Initially, the control unit 201 puts the AC power source circuit unit 231 into the off state to stop the use of AC power supplied from the AC power source line 120, and starts receiving power from the external apparatus (the image processing apparatus 102) via the DC power source line 110. The control unit 201 also controls the power source unit 230 to supply power to a portion of the devices (loads) included in the image processing apparatus 101 that requires power, and stop the supply of power to the other loads.

Specifically, the control unit 201 stops the supply of power from the power source unit 230 to devices which are not used in the power saving state, such as the display unit 204, the image reading unit 208, the image processing unit 209, the image forming unit 210, and the like. On the other hand, the control unit 201 continues to supply minimum required power from the power source unit 230 to a minimum number of devices required for returning from the power saving state, such as the control unit 201, the RAM 203, the operation unit 205, the fax communication unit 206, the network communication unit 207, the USB communication unit 215, and the like.

In the power saving state, the control unit 201 operates with lower power consumption than in the normal operation state, and causes the RAM 203 to operate with lower power consumption (e.g., a self-refresh mode) or at a lower clock frequency than in the normal operation state. As a result, the power consumption of the control unit 201 itself and the RAM 203 is reduced. When the control unit 201 includes a plurality of CPUs, only a CPU having lowest power consumption is allowed to operate.

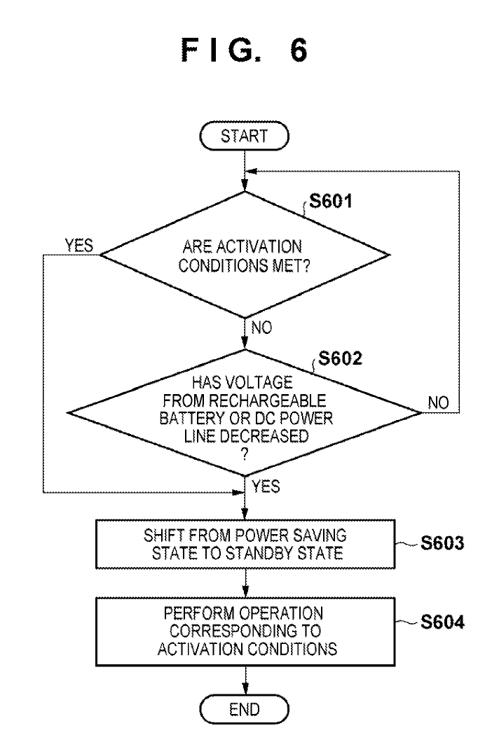

In the power saving state, as described below with reference to FIG. 6, when predetermined activation conditions are met, the control unit 201 returns the image processing apparatus 101 from the power saving state to the normal operation state (standby state). Examples of the predetermined conditions include: the operation unit 205 has been operated by the user; the network communication unit 207 or the USB communication unit 215 has received any information (an instruction, a job, or the like) from an external apparatus; the fax communication unit 206 has received a fax call from an external apparatus; and the like.

Thus, in S509, when the image processing apparatus is shifted to the power saving state, the image processing apparatus uses power supplied from an external apparatus having a higher power supply capability, and does not use its own rechargeable battery 213. Therefore, the frequency of charging/discharging of the rechargeable battery 213 can be reduced. As a result, the life of the rechargeable battery 213 can be increased.

On the other hand, when control proceeds from S507 to S508, in S508 the control unit 201 determines whether or not there is a request for supply of power from any external apparatus via the DC power source line 110. Here, the control unit 201 transmits a signal for determining whether or not there is such a request, by means of PLC, to the external apparatuses connected to the DC power source line 110. Specifically, the control unit 201 negotiates with a responding external apparatus for supply of DC power. As a result, when the control unit 201 has not received such a request, control proceeds to S510, and otherwise, control proceeds to S511. For example, at the current time, if the DC power source (the power source unit 230) of the image processing apparatus 102 is outputting DC power to the DC power source line 110, the control unit 201 does not receive such a request.

In S510, the control unit 201 shifts the image processing apparatus 101 from the standby state (normal operation state) to the power saving state. Initially, the control unit 201 puts the AC power source circuit unit 231 into the off state to stop the use of AC power, and controls the power reception/supply switching unit 310 to cut off the DC/DC voltage converting unit 311 from the DC power source line 110. Moreover, the control unit 201 controls the DC/DC voltage converting unit 311 to supply DC power supplied from the rechargeable battery 213 to a portion of the devices in the circuit 200 that requires power.

Thus, in S510, there is not a power supply request from the external apparatuses, and the image processing apparatus 101 has a higher power supply capability than those of the external apparatuses, and therefore, the control unit 201 does not use the DC power sources of the external apparatuses and shifts the image processing apparatus 101 to the power saving state. In other words, the control unit 201 uses, as a DC power source, the rechargeable battery 213 of the image processing apparatus including that control unit and shifts the image processing apparatus 101 to the power saving state. In this case, the image processing apparatus 101 operates in the standalone mode in the power saving state irrespective of the determination result in S407. The DC/DC voltage converting unit 311 generates a voltage suitable for devices which should be operated in the power saving state, from power obtained from the rechargeable battery 213, and supplies the generated voltage to the devices.

On the other hand, in S511, the control unit 201 supplies power via the DC power source line 110 to an external apparatus without shifting the image processing apparatus 101 from the standby state (normal operation state) to the power saving state. Specifically, the control unit 201 supplies DC power via the DC power source line 110 to an external apparatus because the image processing apparatus including that control unit has a higher power supply capability than that of the external apparatus and the control unit 201 has received a power supply request from the external apparatus.

Initially, the control unit 201 controls the power reception/supply switching unit 310 to enable supply of DC power from the DC power source circuit unit 232 to the DC power source line 110. In this case, the DC power source circuit unit 232 uses the DC/DC voltage converting unit 311 to convert DC power output from the AC power source circuit unit 231 into a voltage suitable for an external apparatus which has transmitted a power supply request in S508, and outputs the voltage to the DC power source line 110. As a result, the power source unit 230 of the image processing apparatus 101 functions as a DC power source for the external apparatus. Note that the voltage suitable for the external apparatus is determined between the apparatuses connected to the DC power source line 110 based on the property information obtained in S504 and the negotiation performed in S508.

<Process of Shifting from Power Saving State to Normal Operation State>

Next, a process of returning from the power saving state to the normal operation state in the image processing apparatus 101 will be described with reference to a flowchart shown in FIG. 6. Operations in steps shown in the flowchart of FIG. 6 are performed in the image processing apparatus 101 by the control unit 201 loading a control program stored in a storage device (the ROM 202 or the like) to the RAM 203 and executing the control program. Note that it is assumed that, in FIG. 6, the image processing apparatus 101 is currently in the power saving state. Therefore, in the image processing apparatus 101, the AC power source circuit unit 231 is in the off state, and power required, for example, for returning from the power saving state is being supplied from the DC power source line 110 or the rechargeable battery 213.

In S601, the control unit 201 determines whether or not the predetermined activation conditions are met in the power saving state. If the control unit 201 determines that the activation conditions are met, control proceeds to S603, and if the activation conditions are not met, control proceeds to S602.

In S602, the control unit 201 determines whether or not the voltage of the rechargeable battery 213 used in the power saving state or the voltage of the DC power source line 110 has decreased. For example, the control unit 201 determines whether or not the voltage has decreased, by determining whether or not the voltage is lower than a predetermined threshold voltage. If the control unit 201 determines that the voltage has decreased, control proceeds to S603, and if the voltage has not decreased, control returns to S601, and the processes of S601 and S602 are repeated.

In S603, the control unit 201 performs a process of shifting the image processing apparatus 101 from the power saving state to the standby state (normal operation state). Initially, the control unit 201 switches the AC power source circuit unit 231 connected to the commercial AC power source line 120 from the off state to the on state, and switches power supply from the power source unit 230 to the circuit 200, from the DC power source circuit unit 232 to the AC power source circuit unit 231. The control unit 201 also resumes power supply from the power source unit 230 to devices which have not received power supply in the power saving state.

The control unit 201 also returns itself from the state in which the control unit 201 is operating with low power consumption to the state in which the control unit 201 is operating with normal power consumption, and returns the clock frequency or power consumption of the RAM 203 to that which is used in the normal operation state. When the control unit 201 includes a plurality of CPUs, the operations of stopped CPUs are resumed. Thereafter, the control unit 201 performs a process of initializing the system to complete the process of shifting the image processing apparatus 101 from the power saving state to the standby state.

After the image processing apparatus 101 has been shifted to the standby state, in S604 the control unit 201 performs a process corresponding to the activation conditions met in S601. For example, in S601, when the image processing apparatus 101 is activated (returned) from the power saving state by receiving a print job from the PC 105 via the LAN 250, the control unit 201 performs a print operation based on the received job. In S601, when the image processing apparatus 101 is activated (returned) from the power saving state due to detection of a decrease in the voltage of the rechargeable battery 213, the control unit 201 charges the rechargeable battery 213 while the image processing apparatus 101 is in the standby state.

As described above, the image processing apparatus of this embodiment, when shifting from the normal operation state to the power saving state, obtains property information indicating a power supply capability from an external apparatus connected to the DC power source line. Based on the obtained property information, the image processing apparatus controls power supply from the power source unit to devices included in that image processing apparatus in the power saving state. Specifically, the image processing apparatus in the power saving state, when the external apparatus has a higher power supply capability than that of that image processing apparatus, supplies power supplied from the external apparatus via the DC power source line, to the devices, and otherwise, supplies power supplied from the rechargeable battery to the devices.

Thus, the image processing apparatus, when there is any of external apparatuses connected thereto via the DC power source line that has a higher power supply capability, receives power required for operation in the power saving state from that external apparatus. As a result, the use of the rechargeable battery in the power saving state can be reduced to the extent possible, whereby the frequency of charging/discharging of the rechargeable battery can be reduced, and therefore, the life of the rechargeable battery can be increased. As a result, a rechargeable battery having a relatively small capacity can be used to save power by the power saving standby function, and therefore, device cost related to the use of the rechargeable battery can be reduced.

When a plurality of image processing apparatuses connected to a DC power source line perform the power saving standby function, any of the image processing apparatuses can receive power from another one (external apparatus) of the image processing apparatuses that has a higher power source efficiency, to shift to the power saving state. Therefore, the power consumption of an entire system including the image processing apparatuses can be efficiently reduced.

<Other Embodiments>

In the above embodiment, it has been assumed that the DC power source line 110 is newly provided separately from the commercial AC power source line 120, the local area network (LAN), the subscriber telephone line, and the like. However, as the DC power source line 110, a line complying with an existing interface standard may be employed. For example, according to the interface standard for the subscriber telephone line 240, the number of pins in a modular jack is six. In Japan, typically, only the middle two of the six pins are used for telephone and fax communication, and two pins at both ends are not used. Therefore, lines corresponding to the unused pins at both ends of the telephone line modular jack (terminal) may be used as a DC power source line.

As the DC power source line 110, a USB cable complying with the USB interface standard may be employed. In the USB interface standard, an apparatus (host) connected to the host connector of the USB cable may supply, by USB bus power (VBUS), a voltage of +5 V to an apparatus (device) connected to the device connector of the USB cable. Therefore, a plurality of image processing apparatuses may be connected together via the USB cable, and the USB cable may be used as the DC power source line 110, whereby the image processing apparatuses may supply power to each other by USB bus power.

A LAN cable may also be employed as the DC power source line 110. In other words, a plurality of image processing apparatuses may supply power to each other by Power over Ethernet (POE) which utilizes a LAN cable to supply power.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-191073, filed Sep. 1, 2011, which is hereby incorporated by reference herein in its entirety.

What is claimed is:

1. An image processing apparatus comprising:
a power source unit configured to, in a normal operation state, supply power supplied from a AC power source to a plurality of devices included in the image processing apparatus and charge a rechargeable battery included in the image processing apparatus, and in a power saving state in which power consumption is lower than in the normal operation state, supply power supplied from the rechargeable battery to a portion of the plurality of devices;
an obtaining unit configured to, in a case where the image processing apparatus shifts from the normal operation state to the power saving state, obtain information indicating a power supply capability of another image processing apparatus connected to the image processing apparatus via a power source line different from a AC power source line through which power is supplied from the AC power source, via the power source line;
a determination unit configured to determine whether or not the power supply capability of the another image processing apparatus indicated by the information obtained by the obtaining unit is higher than that of the image processing apparatus; and
a control unit configured to control the power source unit to supply, to the portion of the plurality of devices, power supplied via the power source line from the another image processing apparatus in a case where the determination unit determines that the power supply capability of the another image processing apparatus is higher than that of the image processing apparatus, and power supplied from the rechargeable battery in a case where otherwise.

2. The image processing apparatus of claim 1, wherein
the power supply capability of the image processing apparatus or the another image processing apparatus is the efficiency of conversion of AC power supplied from the AC power source into DC power in the power source unit included in the power source unit or the another image processing apparatus.

3. The image processing apparatus of claim 1, wherein
the power supply capability of the image processing apparatus or the another image processing apparatus depends on whether the image processing apparatus or the another image processing apparatus is in the normal operation state or in the power saving state, and
the determination unit, when the information obtained by the obtaining unit indicates that the another image processing apparatus is in the normal operation state, determines that the power supply capability of the another image processing apparatus is higher than that of the image processing apparatus.

4. The image processing apparatus of claim 1, wherein
the control unit includes
a request unit configured to, in a case where the determination unit determines that the power supply capability of the another image processing apparatus is higher than that of the image processing apparatus, transmit a power supply request via the power source line to the another image processing apparatus, and
the control unit controls the power source unit to supply, to the portion of the plurality of devices in the power saving state, power supplied via the power source line from the another image processing apparatus in response to the power supply request transmitted by the request unit.

5. The image processing apparatus of claim 4, further comprising:
a reception unit configured to receive the power supply request from the another image processing apparatus via the power source line, wherein
the control unit, in a case where the determination unit determines that the power supply capability of the another image processing apparatus is not higher than that of the image processing apparatus, and the reception unit receives the power supply request from the another image processing apparatus, controls the power source unit to supply power to the another image processing apparatus via the power source line without shifting the image processing apparatus from the normal operation state to the power saving state.

6. The image processing apparatus of claim 5, wherein
the power source unit includes
a first power source circuit unit configured to, in the normal operation state, receive AC power from the AC power source via the AC power source line, convert the AC power into DC power, and supply the DC power to the portion of the plurality of devices, and
a second power source circuit unit configured to, in the normal operation state, receive a DC power from the first power source circuit unit, and charge the rechargeable battery with the supplied DC power, and in the power saving state, supply power stored in the rechargeable battery to the portion of the plurality of devices.

7. The image processing apparatus of claim 6, wherein
in the normal operation state, the second power source circuit unit charges the rechargeable battery with the DC power supplied from the first power source circuit unit, and supplies power to the another image processing apparatus via the power source line under control by the control unit.

8. The image processing apparatus of claim 4, wherein
the power supplied via the power source line between the image processing apparatus and the another image processing apparatus is DC power, and
the obtaining unit and the request unit communicate with the another image processing apparatus via the power source line.

9. The image processing apparatus of claim 1, wherein
the image processing apparatus and the another image processing apparatus are connected together via a telephone line, and one of a plurality of lines included in a cable of the telephone line that is not used for telephone or facsimile communication is used as the power source line.

10. The image processing apparatus of claim 1, wherein
the image processing apparatus and the another image processing apparatus are connected together via a USB cable, the USB cable is used as the power source line, and power is supplied between the image processing apparatus and the another image processing apparatus via the USB cable by USB bus power.

11. A method for controlling an image processing apparatus, the image processing apparatus including a power source unit configured to, in a normal operation state, supply power supplied from a AC power source to a plurality of devices included in the image processing apparatus and charge a rechargeable battery included in the image processing apparatus, and in a power saving state in which power consumption is lower than in the normal operation state, supply power supplied from the rechargeable battery to a portion of the plurality of devices, the method comprising:
in a case where the image processing apparatus shifts from the normal operation state to the power saving state, obtaining information indicating a power supply capability of another image processing apparatus connected to the image processing apparatus via a power source line different from a AC power source line through which power is supplied from the AC power source, via the power source line;
determining whether or not the power supply capability of the another image processing apparatus indicated by the information obtained by the obtaining is higher than that of the image processing apparatus; and
controlling the power source unit to supply, to the portion of the plurality of devices in the power saving state, power supplied via the power source line from the another image processing apparatus in a case where it is determined that the power supply capability of the another image processing apparatus is higher than that of the image processing apparatus, and power supplied from the rechargeable battery in a case where otherwise.

12. A computer-readable storage medium storing a computer program for causing a computer to execute steps of a method for controlling an image processing apparatus, the image processing apparatus including a power source unit configured to, in a normal operation state, supply power supplied from a AC power source to a plurality of devices included in the image processing apparatus and charge a rechargeable battery included in the image processing apparatus, and in a power saving state in which power consumption is lower than in the normal operation state, supply power supplied from the rechargeable battery to a portion of the plurality of devices, the method comprising:
in a case where the image processing apparatus shifts from the normal operation state to the power saving state, obtaining information indicating a power supply capability of another image processing apparatus connected to the image processing apparatus via a power source line different from a AC power source line through which power is supplied from the AC power source, via the power source line;
determining whether or not the power supply capability of the another image processing apparatus indicated by the information obtained by the obtaining is higher than that of the image processing apparatus; and
controlling the power source unit to supply, to the portion of the plurality of devices in the power saving state, power supplied via the power source line from the another image processing apparatus in a case where it is determined that the power supply capability of the another image processing apparatus is higher than that of the image processing apparatus, and power supplied from the rechargeable battery in a case where otherwise.
